(19) United States
(12) Patent Application Publication
(10) Pub. No.: US 2011/0304163 A1
(43) Pub. Date: Dec. 15, 2011

(54) Auto Cam Lock

(76) Inventors: Luke Liang, South Plainfield, NJ (US); David Chen, Guangzhou (CN)

(21) Appl. No.: 12/813,676

(22) Filed: Jun. 11, 2010

(51) Int. Cl. E05C 3/14

(52) U.S. Cl. 292/242; 292/240

(57) ABSTRACT

An auto cam lock is disclosed here. The disclosed auto cam lock comprises a lock housing assembled with a cam and an actuator; a cam adapted to rotate between an extending position and a retracted position, the cam being adapted to be engaged with and retained by the lock housing when the cam is in the retracted position; a cam resilient means for giving the cam a resilient force adapted to drive the cam to rotate from the retracted position to the extending position; an actuator operatively coupled with the cam, said actuator being adapted to move between an extending position and a retracted position, and said the actuator being adapted to release the cam from the cam's retracted position retained by the lock housing when the actuator moves from the actuator's extending position to the actuator's retracted position; and an actuator resilient means for giving the actuator a resilient force adapted to drive the actuator to move from the retracted position to the extending position.

### TECHNICAL FIELD

The present invention relates to windows, and more specifically, to cam latching mechanisms for windows.

### BACKGROUND OF INVENTION

Double hung and other sliding sash type windows are very common. Typically, a latch or locking mechanism is used to secure the sashes in place to inhibit unintentional opening of the sashes and unauthorized entry to the structure.

One very common mechanism used to lock sashes together is the so-called check rail lock, which includes a sweep cam attached to a rotatable handle. The check rail lock is mounted on one of the sashes, usually the lower sash of a double-hung window proximate the center of the sash rail. A keeper structure is mounted on the other sash proximate the check rail lock. As the handle is rotated in either direction, the sweep cam is rotated into or out of engagement with the keeper in order to enable locking or opening of the window as desired. A drawback of these devices, however, is that the handle can be rotated so that the sweep cam is extended even when the sash is open. When the sash is closed with the sweep cam in such position, the extended position of the sweep cam prevents full closure of the sash. The operator of the window may not notice the window is not fully closed and latched. In addition, the sweep cam may strike and damage the other sash.

Another prior mechanism includes a sliding latch bolt that may be mounted on one sash and that is selectively engageable with a keeper mounted on the other sash. A drawback with these mechanisms, however, is often that the bolt must be held in a retracted position as the window is operated. In other case, where a mechanism for holding the bolt in a retracted position is employed, the bolt either releases as soon as the window is raised, or must be manually released with a separate catch or button. In such cases, the window may fail to close fully and may not be noticed by the operator of the window.

Some prior mechanisms have tried to solve the above problems, but the solutions focus on bolt latch. What is still needed is a simple and comfortable cam latch mechanism for a window that automatically latches when the window is returned to a closed position.

### SUMMARY OF THE INVENTION

The present invention addresses the need of the industry for a simple and comfortable cam lock that automatically latches a window when the window is returned to a closed position. According to an embodiment of the invention, a window is equipped with an auto cam lock having a cam and a spring driven actuating mechanism in the housing of the window lock. The auto cam lock is mounted on a sash of a window assembly opposite a keeper or similar cam latch receiving structure. With the window in a closed position, the cam latch is received in the keeper to latch the sashes together, and the actuating mechanism is confined in a retracted position by the keeper. To open the window, the cam latch is disengaged from the keeper by rotating a handle and pulling outwardly away from keeper. The cam latch slides out of the keeper and goes into the housing, and the actuating mechanism is released by the keeper and extends outwardly from the housing and reaches an extended position. The cam latch is held in a retracted position by a stopping mechanism in the housing of the lock. With the cam latch in this position, the sash may be moved to open the window. To close the window, the sash with the auto cam lock is moved toward the keeper. The outwardly extending portion of the actuating mechanism contacts the keeper that pushes the actuating mechanism inwardly into the housing. The actuating mechanism actuates the cam latch and disengages the cam latch from the stopping mechanism. A spring urges the cam latch forwardly so that it is once again engaged in the keeper and the sashes are latched together as before.

According to one embodiment, a cam lock for a window includes a lock; a cam adapted to rotate between an extending position and a retracted position; a cam resilient means for giving the cam a resilient force adapted to drive the cam to rotate from the retracted position to the extending position; an actuator operatively coupled with the cam; and an actuator resilient means for giving the actuator a resilient force adapted to drive the actuator to move from the retracted position to the extending position.

Embodiments of the housing of the latch mechanism may include a top cover and a bottom cover. A hook mechanism and a post-hole mechanism are coupled with the top cover and the bottom cover. The top and the bottom covers can be held together in two steps. The first step is that the post-hole mechanism holds the top cover and the bottom cover together when the hook mechanism does not hold the top cover and the bottom cover. The second step is that the hook mechanism holds the top cover and the bottom cover together with the post-hole mechanism.

The advantage of this invention is a simple and comfortable solution for manufacturers and consumers to manufacture, assemble, install, and use an automatic cam latch for a window.

### BRIEF DESCRIPTION OF THE DRAWINGS

FIG. 1 depicts one exemplary embodiment of the disclosed art.

FIG. 2 is a top exploded view of the exemplary embodiment in FIG. 1.

FIG. 3 is a bottom exploded view of the exemplary embodiment in FIG. 1.

FIG. 4 is a bottom detailed view of the handle in exemplary embodiment in FIG. 1.

FIG. 5 is a top detailed view of the cam in exemplary embodiment in FIG. 1.

FIG. 6 is a top detailed view of the top cover in exemplary embodiment in FIG. 1.

FIG. 7 is a detailed view of the mechanism on the base over of exemplary embodiment in FIG. 1.

FIG. 8 is a bottom detailed view of the actuator of exemplary embodiment in FIG. 1.

FIG. 9 is a top detailed view of the actuator of exemplary embodiment in FIG. 1.

FIG. 10 shows an exemplary assembly process of the disclosed auto cam lock.

FIG. 11 shows an exemplary assembly process and moving process of the assembly cover of the auto cam lock.

FIG. 12 shows the semi-assembled state and the final-assembled state of the lock.

FIG. 13 A-D show the action process of the lock.

FIG. 14 A-E show the detailed action process of the lock.

FIG. 15 shows the work process of the indicator.

### DETAILED DESCRIPTION OF THE INVENTION

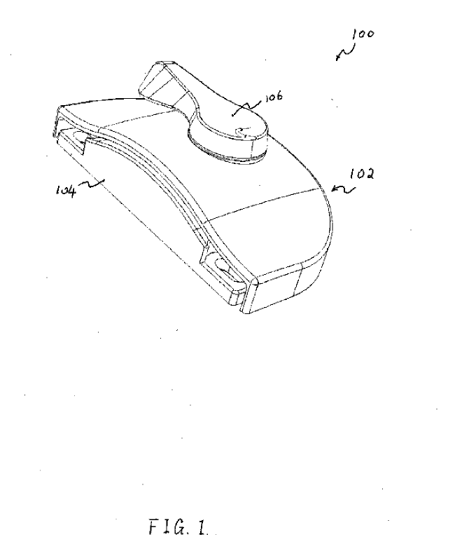

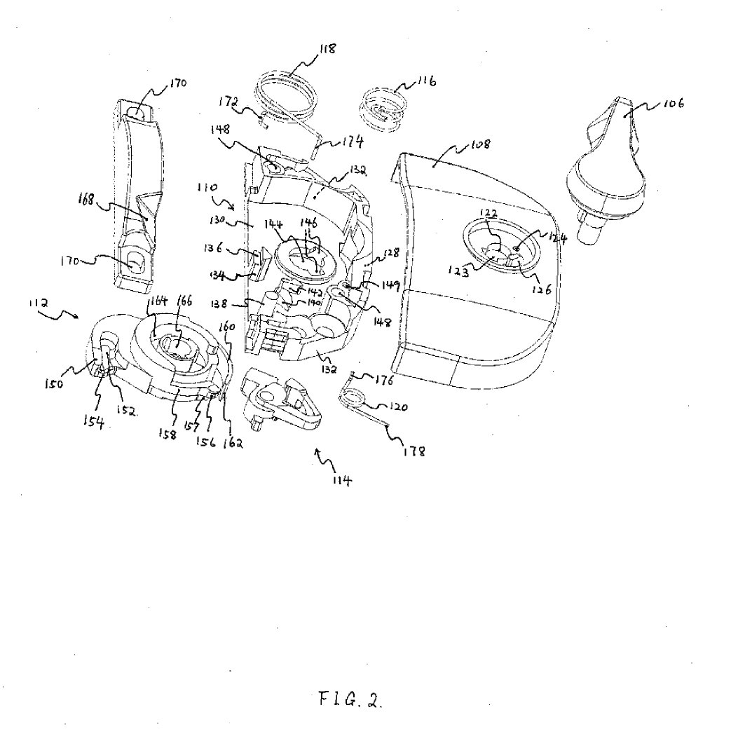

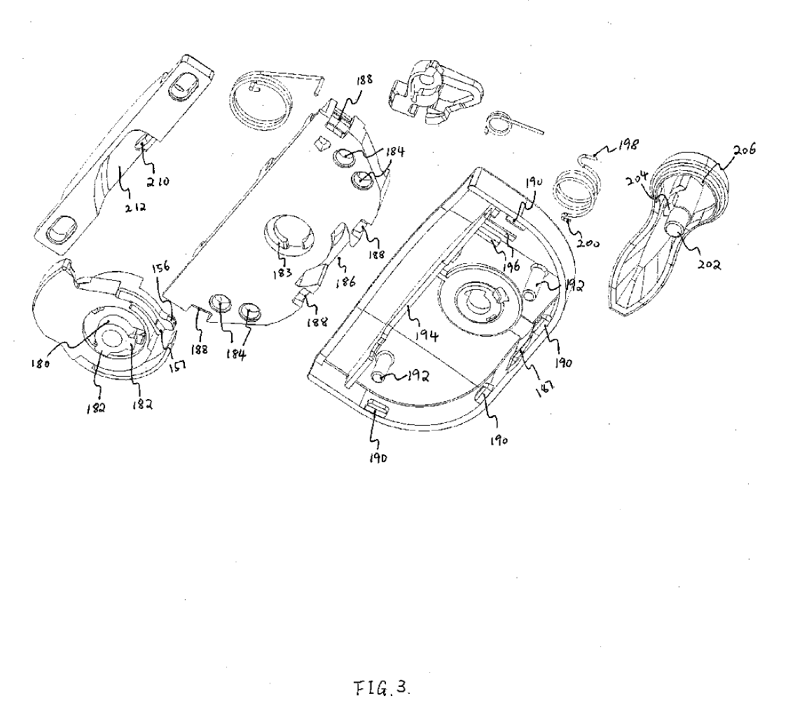

FIG. 1 is one exemplary embodiment of the disclosed art. FIG. 2 is a top exploded view of the exemplary embodiment in FIG. 1. FIG. 3 is a bottom exploded view of the exemplary embodiment in FIG. 1. Auto cam lock 100 in FIG. 1 includes lock housing 102, cam receiver 104, and handle 106 (shown in FIG. 1). Lock housing 102 includes top cover 108 and base cover 110. In lock housing 102, there are further cam 112, actuator 114, cam spring 118, and actuator spring 120. Between handle 106 and top cover 108, there is handle spring 116. Those skilled in the art will realize and understand, upon reading this description, that resilient elements other or different than springs may be used to fulfill the same function.

Top cover 108 further includes top cover shaft hole 122, top cover shaft hole breach 123, top cover spring hole 124, and an one-way pass element that can be resilient lobe 126. Top cover 108 further includes four top cover hooks 190, a pair of top cover post 192, top cover front wall 194, housing indicator window 187, and actuator fixing beam 196.

Base cover 110 includes rear wall 128, bottom wall 130, and a pair of side walls 132. Base cover 110 further includes base projection 140, a cam stop element that can be base stop post 134, base stop post stair 136, base actuator post 138, base cam stop pin 142, base cam hole 144, base cam spring hole 149, a pair of base cam hole breaches 146, and a pair of base cover holes 148. Base cover 110 further includes four base cover screw holes 184, base indicator window 186, cam hole edge 183, and four base cover hooks 188 (shown in FIG. 3).

Cam 112 includes cam latch 150, cam groove 152, cam stop wall 154, cam actuate pin 156, can stop pin 157, cam stop pin arm 158, cam indicator arm 160, cam indicator 162, cam spring slot 164, and cam handle hole 166. Cam 112 further includes cam shaft 180 and a pair of cam shaft projections 182 (shown in FIG. 3).

Cam receiver 104 includes receiver bevel wall 168 and a pair of receiver screw hole 170. Cam receiver 104 further includes receiver keeper 210 and receiver guide slot 212 (shown in FIG. 3).

Cam spring 118 includes cam spring cam hook 172 and cam spring base hook 174. Actuator spring 120 includes actuator spring actuator hook 176 and actuator spring extension 178. Handle spring 116 includes handle spring handle hook 198 and handle spring cover hook 200 (shown in FIG. 3). FIG. 5 is a top detailed view of the cam in exemplary embodiment in FIG. 1. Cam 112 further includes handle guide slot 214 and cam spring hole 216.

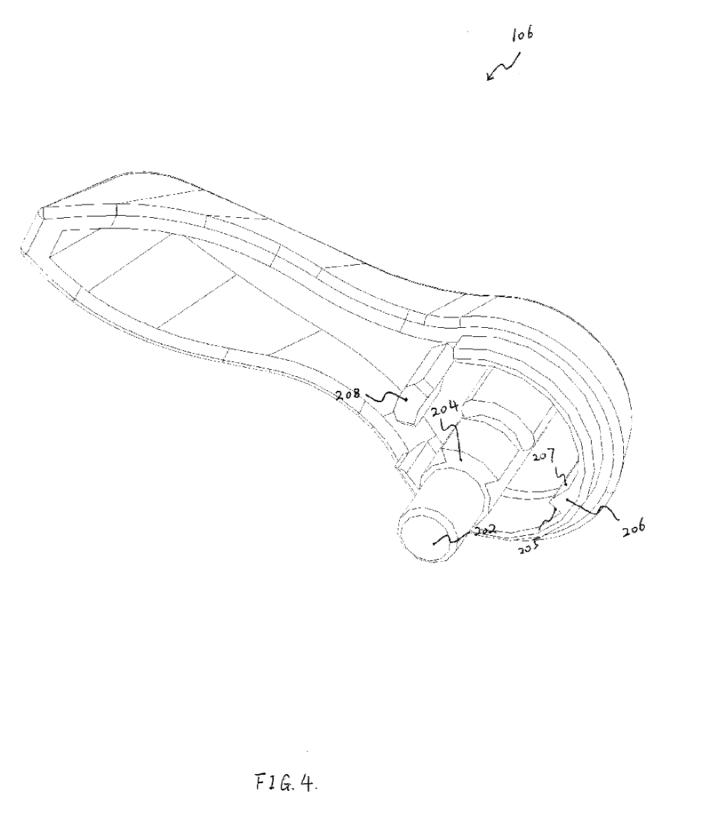

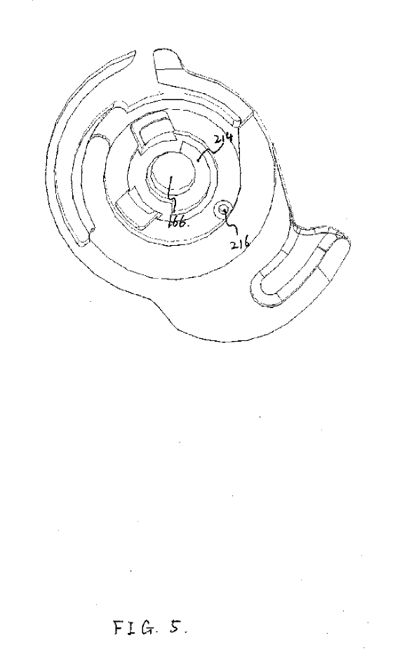

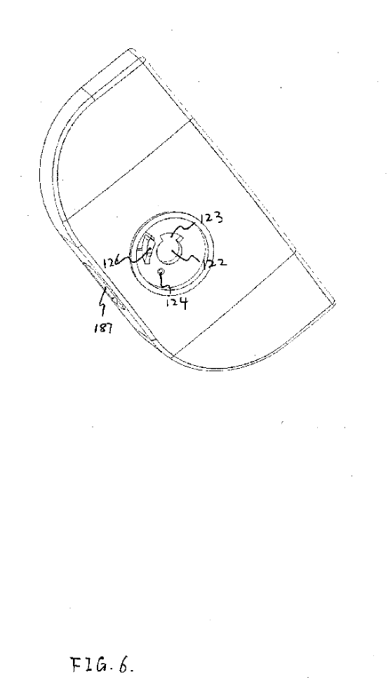

FIG. 4 is a bottom detailed view of the handle in exemplary embodiment in FIG. 1. Handle 106 includes handle shaft 202, handle shaft projection 204, handle stop 206, hand stop bevel side 207, handle stop wall 205, and handle spring tab 208.

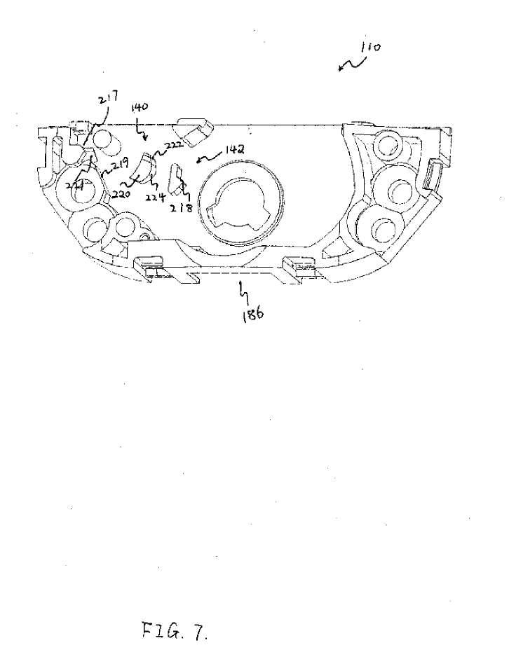

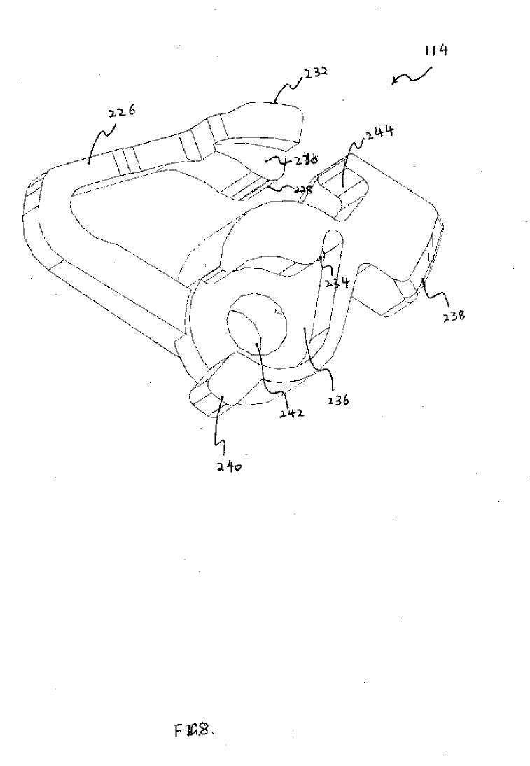

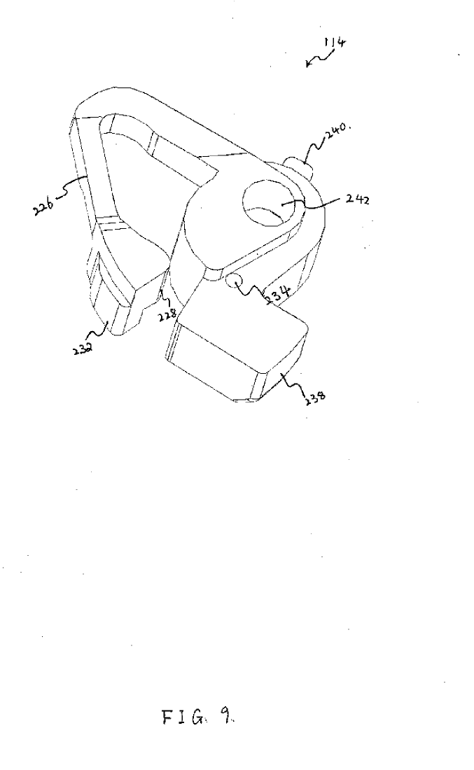

FIG. 7 is a detailed view of the mechanism on the base over of exemplary embodiment in FIG. 1. Base cam stop pin 142 on base cover 110 further includes base cam stop point 218. Base projection 140 on base cover 110 further includes base slide chamfer 220, block wall 222, and arc side 224. Base cover 110 further includes actuator spring stop wall 219, actuator stop wall 221, and an actuator stop element that can be actuator stop slot 217.

FIG. 8 is a bottom detailed view of the actuator of exemplary embodiment in FIG. 1. Actuator 114 further includes actuator arm 226, actuator block point 228, actuator slide chamfer 230, and actuate point 232. These elements can also be seen from FIG. 9 from a different perspective. Actuator 114 further includes actuator spring hole 234, actuator spring slot 236, actuator tongue 238, actuator stop point 240, actuator post hole 242, and actuator bottom slot 244. Those skilled in the art will realize and understand, upon reading this description, that other and or different elements may be included to fulfill the same function.

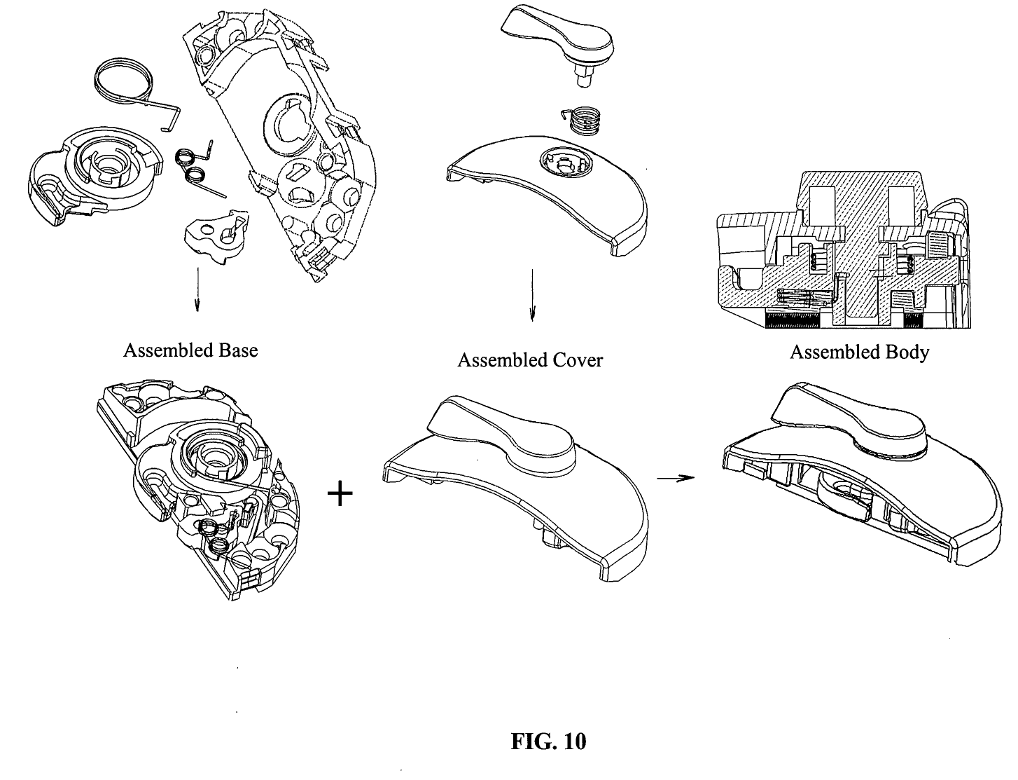

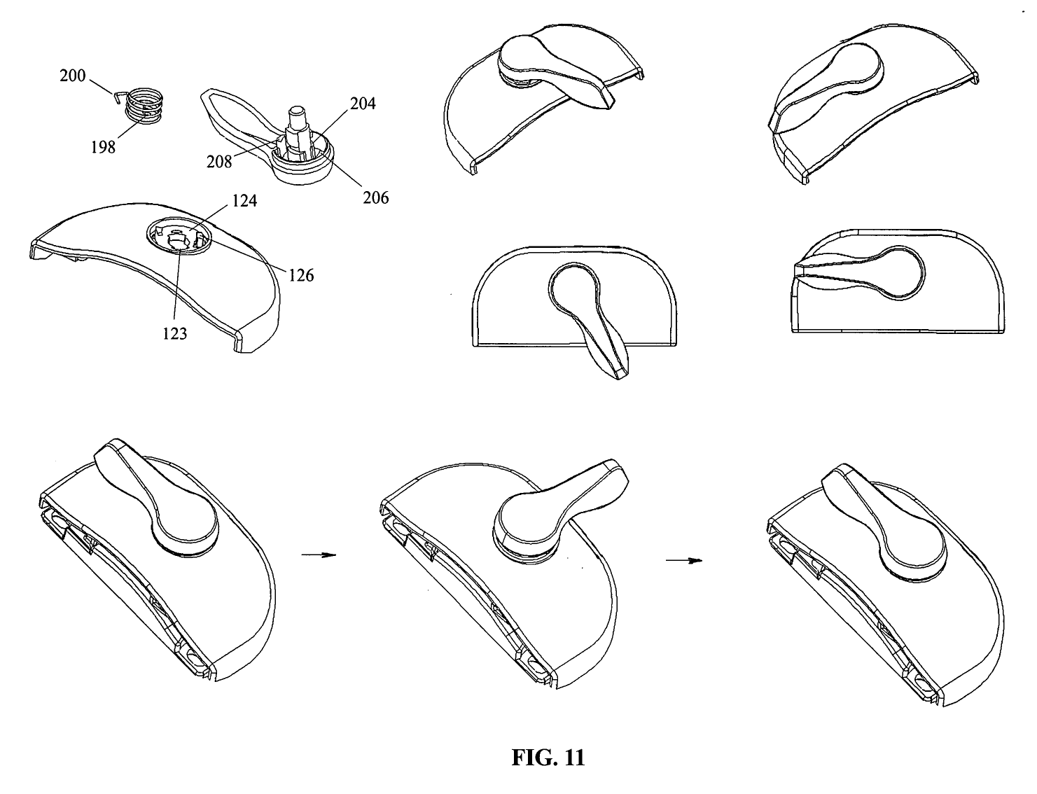

One exemplary assembly process is shown in FIG. 10. The exemplary assembly process generally includes the flowing steps. Cam spring 118 is mounted in cam spring slot 164, wherein cam spring cam hook 172 grips cam 112 through cam spring hole 216 and wherein cam spring base hook 174 is inserted into base cam spring hole 149. Cam 112 is mounted on base cover 110, wherein cam shaft 180 goes through base cam hole 144 and wherein cam shaft projections 182 go through base cam hole breaches 146. The mounted cam spring 118 is in a pre-tight state that gives cam 112 a counterclockwise torque (from the top view). This counterclockwise torque rotates cam 112 until cam stop wall 154 pushes against base stop post 134. This rotation also makes cam shaft projections 182 move away from base cam hole breaches 146 after cam shaft projections 182 go through base cam hole breaches 146. Thus, cam shaft projections 182 hold cam 112 on cam hole edge 183. Actuator spring 120 is mounted into actuator spring slot 236, wherein actuator spring actuator hook 176 grips actuator 114 through actuator spring hole 234. Actuator spring extension 178 pushes against actuator spring stop wall 219. Actuator 114 is mounted on base cover 110, wherein base actuator post 138 goes through actuator post hole 242 and wherein actuator stop point 240 goes through actuator stop slot 217. Actuator spring 120 is in a pre-tight state that gives actuator 114 a counterclockwise torque (from the top view). This counterclockwise torque rotates actuator 114 until actuator stop point 240 pushes against actuator stop wall 221. These steps lead to an assembled base shown in FIG. 10.

Handle spring 116 is mounted on top cover 108, wherein handle spring cover hook grips top cover 108 by going through top cover spring hole 124. Handle spring handle hook 198 grips handle spring tab 208. Handle 106 is pushed toward top cover 108 wherein handle shaft 202 goes through top cover shaft hole 122 and wherein handle shaft projection 204 goes through top cover shaft hole breach 123. After handle shaft projection 204 goes through top cover shaft hole breach 123, handle 106 is rotated in clockwise, wherein handle shaft projection 204 moves away from top cover shaft hole breach 123, and wherein handle stop 206 passes resilient lobe 126. Handle shaft projection 204 moves away from top cover shaft hole breach 123 so that handle shaft projection 204 can hole handle 106 on top cover 108. Handle stop 206 can pass resilient lobe 126 because resilient lobe 126 is pushed centripetally by handle stop 206 and slides on handle stop 206 along handle stop bevel side 207. Once handle stop 206 passes resilient lobe 126, it cannot pass back since resilient lobe 126 resumes to its original position and blocks handle stop wall 205. Handle spring 116 is in a pre-tight state that gives handle 106 a counterclockwise torque, and handle 106 is rotated until handle stop 206 pushes against resilient lobe 126. These steps are shown in FIG. 11, and these steps lead to assembled cover shown in FIG. 10.

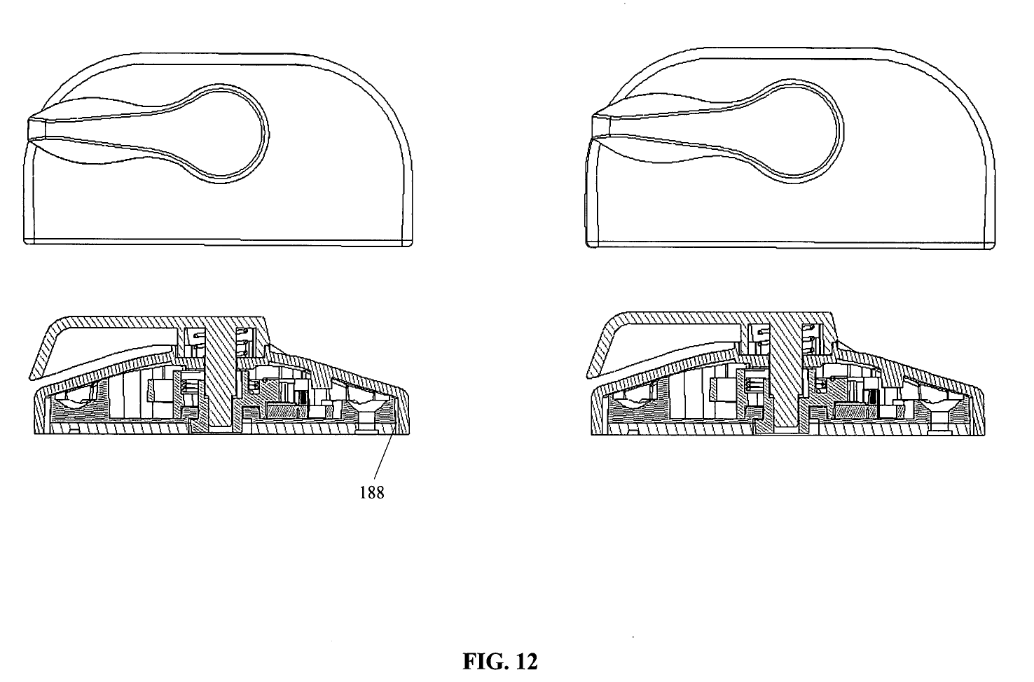

The assembled cover is further mounted on the assembled base. Handle shaft 202 goes through cam handle hole 166. Handle shaft projection 204 goes into handle guide slot 214. Handle guide slot 214 is fan-shaped with two straight sides. Handle shaft projection 204 is adapted to move from one straight side to the other straight side when handle 106 rotates relatively to cam 112. Top cover posts are pushed into base cover holes 148. The lock body has two assembled states: semi-assembled state and final assemble state. In semi-assembled state, top cover hooks 190 rest on base cover hooks 188. In final assembled state, top cover hooks 190 are further pushed downward and top cover hooks 190 and base cover hooks 188 hold together. The assembled cover is relatively easy to be moved from the assembled base in semi-assembled state. Semi-assembled state is delivered from lock manufactures to window manufacturers for the purpose of mounting locks on windows. The assembled cover needs to be removed since screw holes 184 are on base cover 110. When the lock is mounted on the window, window manufacturers can further push the assembled cover down to the final assembled state. In final assembled state, the assembled cover is relatively difficult to be moved from the assembled base. The semi-assembled state and the final assembled state are shown in FIG. 12. The assembled body of auto cam lock 100 is shown in FIG. 10. In the final assembled state, actuator fixing beam 196 pushes against actuator 114, and thus keeps actuator 114 in a proper position during its action process. Those skilled in the art will realize and understand, upon reading this description, that other and or different assemble processes may be used to fulfill the same function.

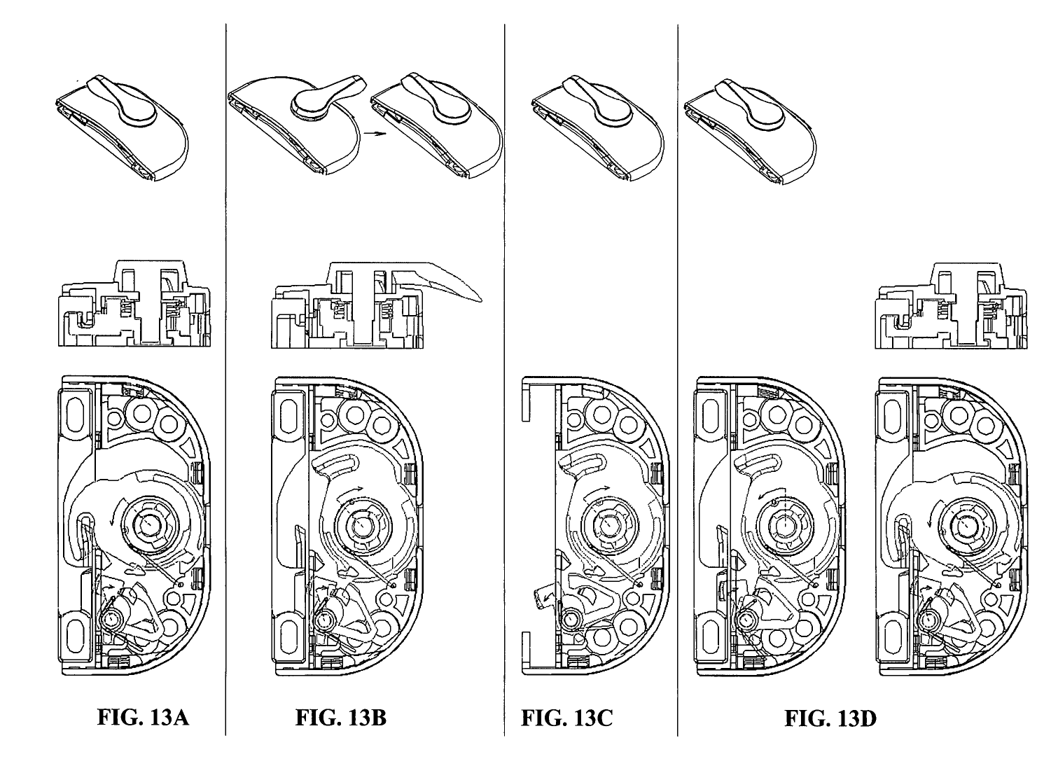

FIG. 13 A-D show the action process of the lock. FIG. 13-A depicts the lock state of auto cam lock 100. The following elements can be found in FIG. 2 and FIG. 3. Cam latch 150 rotates out of lock housing 102 into cam receiver 104. Receiver keeper 210 goes into cam groove 152. Thus, cam 112 is held by cam receiver 104. Actuator 114 is in a retracted position in lock housing 102, wherein receiver bevel wall 168 pushes against actuator tongue 238.

FIG. 13-B depicts the unlock process of auto cam lock 100. Handle 106 rotates clockwise (from the top view). Handle shaft projection 204 pushes one side of handle guide slot 214 (shown in FIG. 5), which rotates cam 112 clockwise (from the top view). Cam latch 150 rotates out of cam receiver 104 and into lock housing 102. Before the assembled body (shown in FIG. 10) clears cam receiver 104, actuator 114 is in a retracted position in lock housing 102 and receiver bevel wall 168 pushes against actuator tongue 238. Handle 106 rotates back counterclockwise to its initial position under the torque given by handle spring 116.

FIG. 13-C depicts the open state of auto cam lock 100. Cam stop pin 157 is held by base cam stop point 218. Thus cam 112 is kept in the retracted position. The assembled body clears cam receiver 104. Without being pushed by receiver bevel wall 168, actuator 114 extends out of lock housing 102 under the torque given by actuator spring 120.

FIG. 13-D depicts the lock process of auto cam lock 100. When the assembled body contacts cam receiver 104, receiver bevel wall 168 pushes against actuator tongue 238. Actuator 114 is back to the retracted position in lock housing 102. In this process, actuate point 232 pushes cam actuate pin 156. Cam stop pin 157 is released from base cam stop point 218. Cam 112, under the resilient torque given by cam spring 118, rotates counterclockwise (from the top view) from lock housing 102. Cam latch 150 rotates out of lock housing 102 into cam receiver 104. Receiver keeper 210 goes into cam groove 152. Auto cam lock 100 is locked as before.

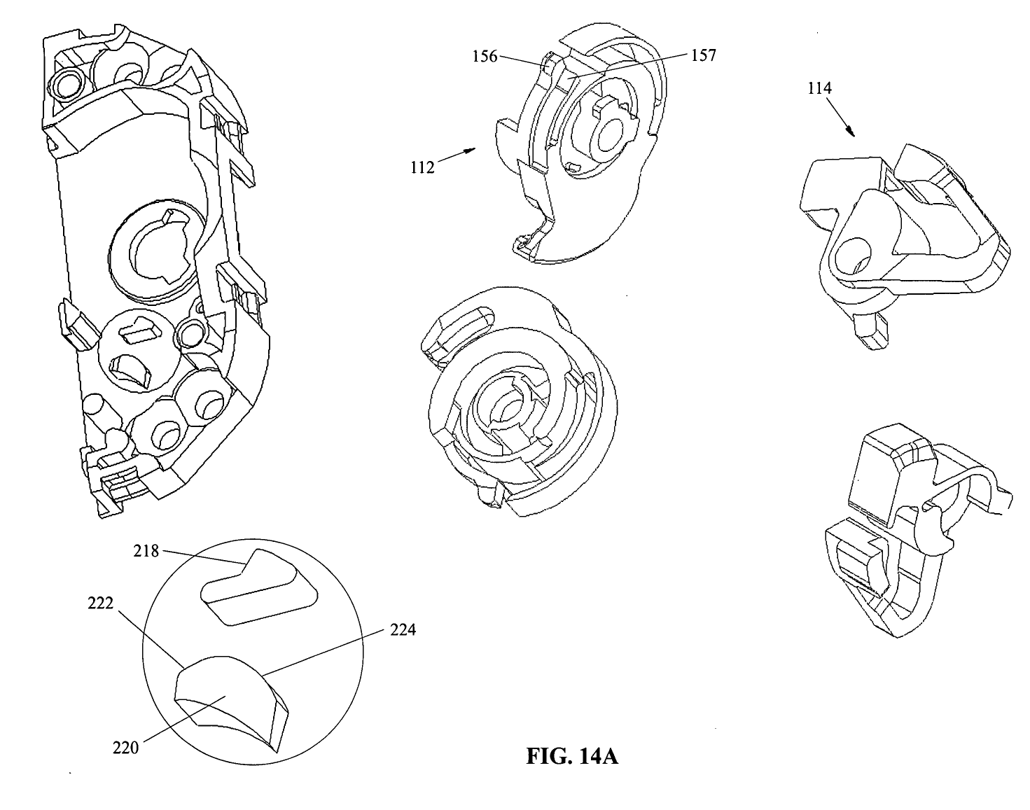

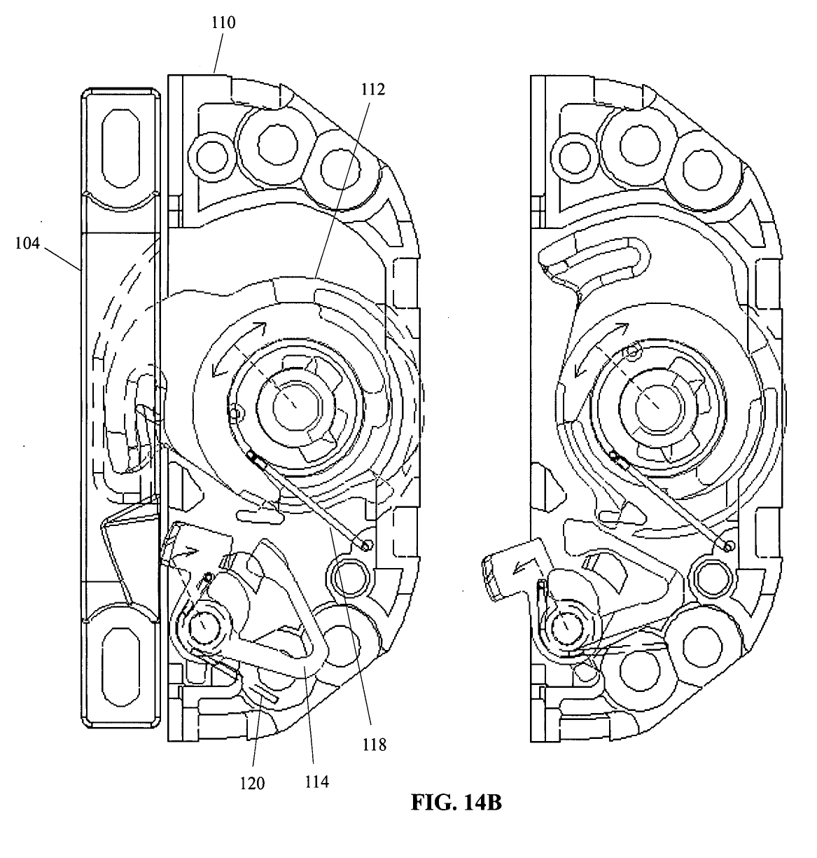

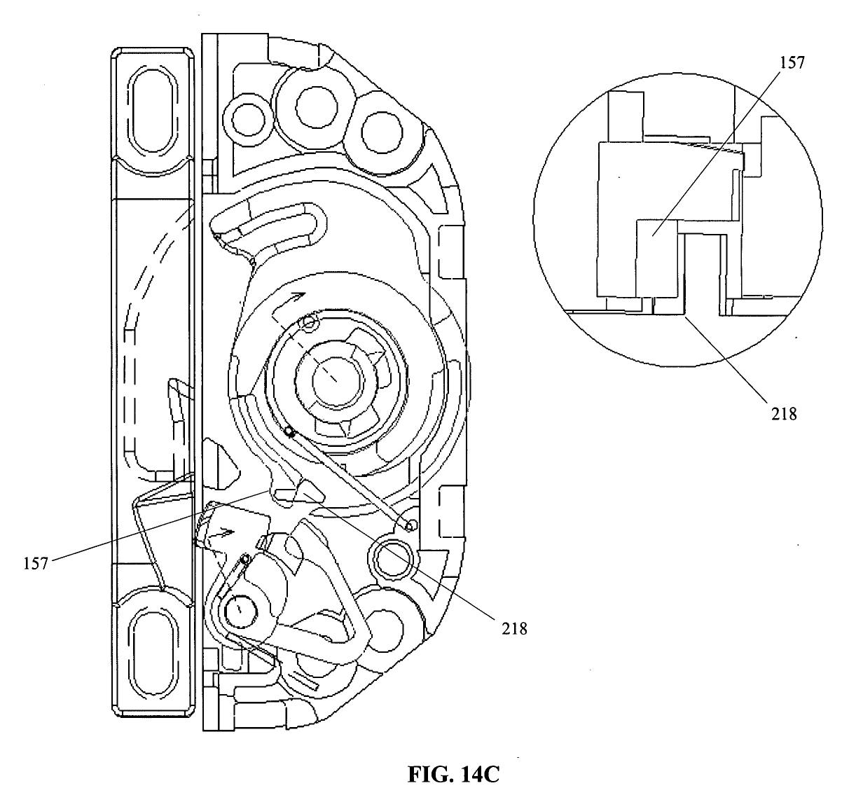

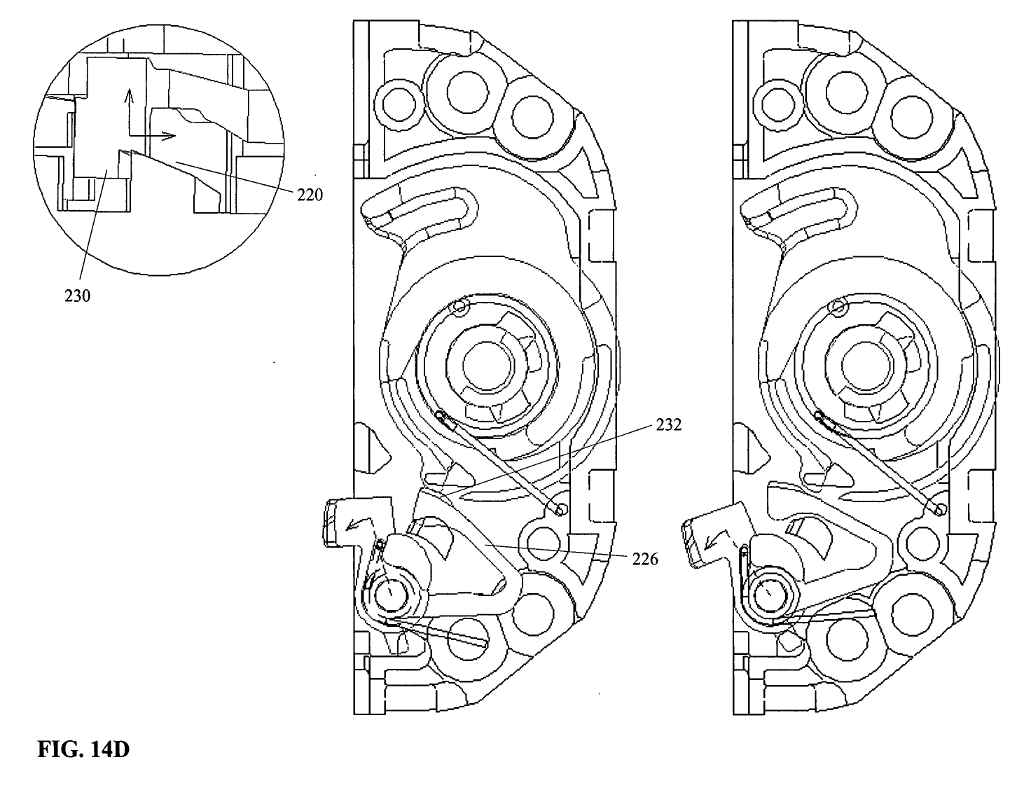

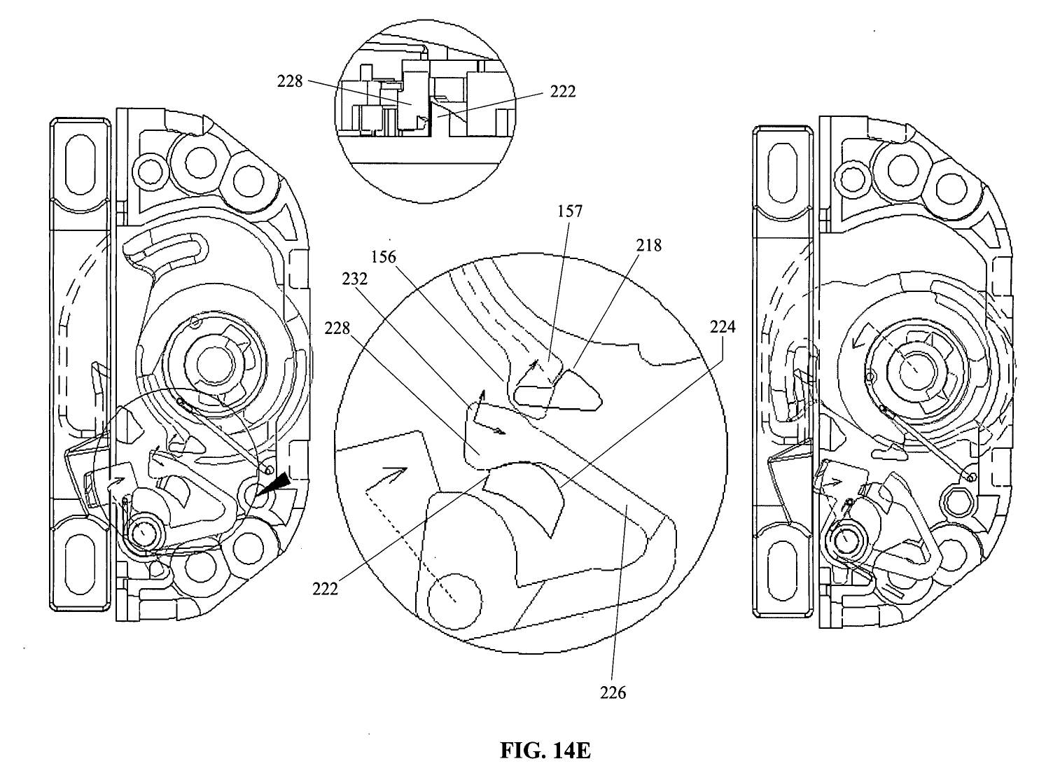

FIG. 14 A-E show the detailed action process of auto cam lock 100. FIG. 14-A shows elements used in FIG. 14 C-E. These elements also exist in FIG. 2, FIG. 3, and FIG. 7-9. FIG. 14-B depicts the locked and unlocked states of auto cam lock 100. FIG. 14-C depicts the lock position of auto cam lock 100. Cam stop pin 157 is held by base cam stop point 218. Actuator slide chamfer 230 rests on base side chamfer 220.

FIG. 14-D depicts the unlock process of auto cam lock 100. Actuator 114 extends out of lock housing 102 under the torque given by actuator spring 120. During this process, actuator slide chamfer 230 slides counterclockwise (from a top view) along base slide chamfer 220. Since both actuator slide chamfer 230 and base slide chamfer 220 are bevel-shaped, actuator arm 226 is lifted upwardly in this process, and actuate point 232 does not touch cam actuate pin 156. After actuator 114 extends out of lock housing 102, actuator slide chamfer 230 clears base slide chamfer 220 and actuator arm 226 resumes its horizontal position.

FIG. 14-E depicts the lock process of auto cam lock 100. Receiver bevel wall 168 pushes against actuator tongue 238. When actuator 114 goes back to the retracted position in lock housing 102, actuator block point 228 contacts block wall 222 so that actuator slide chamfer 230 cannot slide onto base slide chamfer 220. Actuator block point 228 slides along arc slide 224. During this process, actuate point 232 is pushes centrifugally by base projection 140. Thus, actuate point 232 touches cam actuate pin 156 and release cam stop pin 157 from base cam stop pin 142. Cam 112 is actuated and, under the resilient torque given by cam spring 118, rotates counterclockwise (from the top view) from lock housing 102. Auto cam lock 100 is locked as before. Those skilled in the art will realize and understand, upon reading this description, that other and or different actuating processes may be used to fulfill the same function.

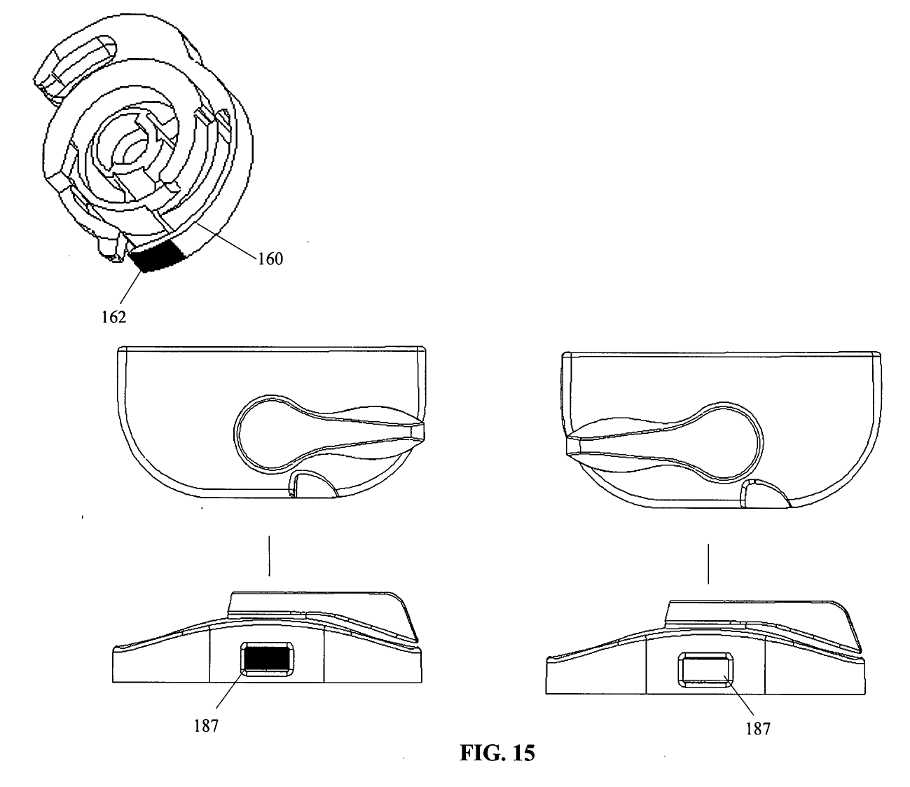

FIG. 15 shows the work process of cam indicator 162. When top cover 108 is mounted on base cover 110, base indicator window 186 overlaps with housing indicator window 187. At one end of cam indicator arm 160, there is a cam indicator 162 that has a different color than other part of cam indicator arm 160. One exemplary color for cam indicator 162 is red, and the rest part of cam indicator arm 160 is white. When cam 112 extends out of lock housing 102, cam indicator 162 overlaps with housing indicator window 187, so cam indicator 162 cam be seen from outside. When cam 112 is in the retracted position, the other part of cam indicator arm 160 overlaps with housing indicator window 187. Therefore, the locked position and the unlocked position can be told from the color in housing indicator window 187 from outside. Those skilled in the art will realize and understand, upon reading this description, that other and or different indicating mechanisms may be used to fulfill the same function.

The disclosed art can have different embodiments with various screw holes. Multiple screw locations increase the adaptability of this latch mechanism to many window systems, including but not limited to, sliding window systems and double-hung window systems. Those skilled in the art will also realize and understand, upon reading this description, that other and or different screw locations may be used to adapt this latch mechanism to various window systems.

What is claimed is:

1. An auto cam lock, comprising:
a lock housing assembled with a cam and an actuator;
a cam adapted to rotate between an extending position and a retracted position, the cam being adapted to be engaged with and retained by the lock housing when the cam is in the retracted position;
a cam resilient means for giving the cam a resilient force adapted to drive the cam to rotate from the retracted position to the extending position;
an actuator operatively coupled with the cam, said actuator being adapted to move between an extending position and a retracted position, and said the actuator being adapted to release the cam from the cam's retracted position retained by the lock housing when the actuator moves from the actuator's extending position to the actuator's retracted position; and
an actuator resilient means for giving the actuator a resilient force adapted to drive the actuator to move from the retracted position to the extending position.

2. The auto cam lock in accordance with claim 1, wherein the actuator is adapted to rotate between the extending position and the retracted position.

3. The auto cam lock in accordance with claim 1, wherein the cam resilient means comprises a cam spring and the actuator resilient means comprises actuator spring.

4. The auto cam lock in accordance with claim 3, wherein one end of the actuator spring is connected to the actuator and the other end of the actuator spring pushes against a wall on the lock housing, and said actuator spring being adapted to give the actuator a resilient torque when the actuator and the actuator spring are mounted in the lock housing.

5. The auto cam lock in accordance with claim 3, wherein one end of the cam spring is connected to the cam and the other end of the cam spring is connected to the lock housing, said cam spring being adapted to give the cam a resilient torque when the cam and the cam spring are mounted in the lock housing.

6. The auto cam lock in accordance with claim 1, wherein when the actuator moves from the actuator's retracted position to the actuator's extending position, the actuator is adapted to avoid the cam when the cam is in the cam's retracted position.

7. The auto cam lock in accordance with claim 6, wherein the actuator further comprises an actuate point adapted to release the cam from the cam's retracted position engaged by the lock housing, and the lock housing further comprises a guide projection adapted to guide the actuate point to move on a predetermined tract.

8. The auto cam lock in accordance with claim 1, wherein the lock housing further comprises a cam stop element adapted to push against the cam when the cam is in its extending position and prevent the cam from moving further than its extending position caused by the cam resilient means.

9. The auto cam lock in accordance with claim 8, wherein the cam stop element comprises a cam stop post.

10. The auto cam lock in accordance with claim 1, wherein the lock housing further comprises an actuator stop element adapted to push against the actuator when the actuator is in its extending position and prevent the actuator from moving further than its extending position caused by the actuator resilient means.

11. The auto cam lock in accordance with claim 10, wherein the actuator stop element comprises an actuator stop slot.

12. The auto cam lock in accordance with claim 1, wherein the lock housing further comprises a cam stop pin adapted to engage with the cam and keep the cam in its retracted position.

13. The auto cam lock in accordance with claim 1, wherein the lock housing further comprises a base cover and a top cover.

14. The auto cam lock in accordance with claim 13, wherein the top cover is adapted to be assembled with the base cover in a semi-assembled state and in a final-assembled state, said semi-assembled state being relatively easy to be disassembled and the final-assembled state being relatively difficult to be disassembled.

15. The auto cam lock in accordance with claim 14, wherein the top cover and the base cover further comprise a hole and a post, said post being inserted into the hole when the top cover and the base cover are in semi-assembled state.

16. The auto cam lock in accordance with claim 14, wherein both of the top cover and the base cover further comprises a hook, said hook on the top cover gripping the hook on the base cover when the top cover and the base cover are in final assembled state.

17. The auto cam lock in accordance with claim 1, wherein the auto cam lock further comprises an indicating means for indicating the locked and unlocked states of the auto cam lock.

18. The auto cam lock in accordance with claim 17, wherein the indicating means comprises an indicator arm adapted to rotate with the cam, said indicator arm comprising two parts with different colors, and one of the two parts being shown in the locked state and the other being shown in the unlocked state.

19. The auto cam lock in accordance with claim 1, wherein the auto cam lock further includes a cam receiver adapted to engage with the cam when the cam rotates to its extending position.

20. The auto cam lock in accordance with claim 19, wherein the cam further comprises a cam latch and a cam groove, said the cam receiver further comprising a receiver keeper and a receiver guide slot, and when the cam is engaged with the cam receiver, the cam latch rotates into the receiver guide slot and the receiver keeper goes into the cam groove.

21. The auto cam lock in accordance with claim 19, wherein the cam receiver further comprises a receiver bevel wall adapted to push the actuator from its extending position to its retracted position when the lock housing meets the cam receiver.

22. The auto cam lock in accordance with claim 1, wherein the auto cam lock is adapted to be used on different kinds of windows.

23. A cam lock comprising:
a lock housing;
a cam in the lock housing, said cam being adapted to rotate between an extending position and a retracted position;
a handle operatively coupled with the cam, said handle being adapted to move the cam from the extending position to the retracted position; and
a resilient element coupled with the handle, said resilient element being adapted to resume the handle's initial position after the cam is engaged with the lock housing in the cam's retracted position.

24. The auto cam lock in accordance with claim 23, wherein the handle further comprises a spring, said spring comprising two ends, one of the ends being connected to the handle and the other of the ends being connected to the lock housing.

25. The auto cam lock in accordance with claim 23, wherein the handle further comprises a retaining element adapted to engage the handle with the lock housing and retain the handle on the lock housing.

26. The auto cam lock in accordance with claim 25, wherein the lock housing further comprises a hole on the surface of the lock housing and the retaining element comprises a shaft on the inner surface of the handle and a projection on the shaft, said shaft being adapted to go through the hole, and said projection on the shaft being adapted to retain the handle on the lock housing.

27. The auto cam lock in accordance with claim 26, wherein the handle further comprises a stop element, the lock housing further comprises an one-way pass element, and the hole further comprises a breach on the edge of the hole, the projection being adapted to go through the breach when the handle is being assembled on the lock housing, the stop element being adapted to pass the one-way pass element after the projection goes through the breach, the projection being adapted to retain the handle on the lock housing after the stop element passes the one-way pass element, and the one-way pass element being adapted to prevent the stop element from passing back after the stop element passes the one-way pass element.

28. The auto cam lock in accordance with claim 27, wherein the stop element comprises a bevel surface and a stop wall, and the one-way pass element comprises a resilient lobe with a sliding surface, said bevel surface being adapted to slide along the sliding surface on the sliding surface, said resilient lobe being adapted to be bent by the stop element when the bevel surface slides on the sliding surface, and said stop wall being adapted to prevent the bevel surface from sliding back after the stop element passes the one-way pass element.

29. An auto cam lock, comprising:
a lock housing assembled with a cam and an actuator;
a cam adapted to rotate between an extending position and a retracted position, the cam being adapted to be engaged with and retained by the lock housing when the cam is in the retracted position;
a cam spring arranged to give the cam a resilient force adapted to drive the cam to rotate from the retracted position to the extending position;
an actuator operatively coupled with the cam, said actuator being adapted to rotate between an extending position and a retracted position, and said the actuator being adapted to release the cam from the cam's retracted position retained by the lock housing when the actuator moves from the actuator's extending position to the actuator's retracted position;
an actuator spring to give the actuator a resilient force adapted to drive the actuator to move from the retracted position to the extending position;
a handle operatively coupled with the cam to move the cam from the extending position to the retracted position, said handle comprising a handle spring to resume the handle's initial position after the cam is moved by the handle from the extending position to the retracted position; and
an indicator adapted to indicate the locked and unlocked states of the auto cam lock, said indicator comprising an indicator arm adapted to rotate with the cam, said indicator arm comprising two parts with different colors, and one of the two parts being shown in the locked state and the other being shown in the unlocked state.
